(19) United States
(12) Patent Application Publication
(10) Pub. No.: US 2024/0005581 A1
(43) Pub. Date: Jan. 4, 2024

(54) GENERATING 3D FACIAL MODELS & ANIMATIONS USING COMPUTER VISION ARCHITECTURES

(71) Applicant: VIDALIGN INC., Palisades Park, NJ (US)

(72) Inventors: Amrish Baskaran, Columbus, OH (US); Adheesh Chatterjee, College Park, MD (US); James Tristan Guerrera-Sapone, Southpark, CT (US); Sammie Kim, Palisades Park, NJ (US)

(21) Appl. No.: 18/342,493

(22) Filed: Jun. 27, 2023

Related U.S. Application Data
(60) Provisional application No. 63/357,399, filed on Jun. 30, 2022.
(60) Provisional application No. 63/382,179, filed on Nov. 3, 2022.

(51) Int. Cl. G06T 13/40; G06V 40/16

(52) U.S. Cl. CPC G06T 13/40; G06V 40/168; G06V 40/161

(57) ABSTRACT

This disclosure relates to improved techniques for generating three-dimensional (3D) facial models and animations from two-dimensional (2D) electronic media files. Other embodiments are disclosed herein as well.

### CROSS-REFERENCE TO RELATED APPLICATIONS

This application claims benefit of, and priority to, U.S. Provisional Patent Application No. 63/357,399 filed on Jun. 30, 2022 and U.S. Provisional Patent Application No. 63/382,179 filed on Nov. 3, 2022. The contents of the above-identified applications are herein incorporated by reference in their entireties.

### TECHNICAL FIELD

This disclosure is related to improved systems, methods, and techniques for generating three-dimensional (3D) facial models. In certain embodiments, a computer vision system utilizes machine learning techniques to extract 3D facial models from two-dimensional (2D) videos and/or images, and generate digital animations (or other digital content) using the 3D facial models. In some cases, the 3D facial models can be stored in objects or files that permit developers or other users to modify, customize, and/or adjust the 3D facial models and/or corresponding animations.

### BACKGROUND

Digital artists, developers, and/or other users commonly seek to create facial animations and/or other digital content that incorporates facial animations. Creating these facial animations typically requires accurate identification of 3D facial information. Current techniques for obtaining this 3D facial information and generating facial animations are largely manual processes, which are tedious, time-consuming, and technically difficult to implement.

### BRIEF DESCRIPTION OF DRAWINGS/ATTACHMENTS

To facilitate further description of the embodiments, the following drawings are provided, in which like references are intended to refer to like or corresponding parts, and in which:

FIG. 1A is a diagram of an exemplary system in accordance with certain embodiments;

FIG. 1B is a block diagram demonstrating exemplary features of a computer vision system in accordance with certain embodiments;

FIG. 2 is a block diagram illustrating an exemplary configuration and process flow for a computer vision system according to certain embodiments; and

FIG. 3 is a block diagram illustrating an exemplary configuration and process flow and for a texture-tracking model according to certain embodiments.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein.

The terms “left,” “right,” “front,” “rear,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

### DETAILED DESCRIPTION OF EXEMPLARY EMBODIMENTS

The present disclosure relates to systems, methods, apparatuses, computer program products, and techniques for extracting, generating, and utilizing 3D facial models. In certain embodiments, a computer vision system can be configured to extract 3D facial models from 2D electronic media content (e.g., digital images and/or videos), and generate digital animations using the 3D facial models. The computer vision system can include a neural network architecture that is trained to perform, inter alia, facial shape estimation, facial expression tracking, and facial object localization functions. In some scenarios, the machine learning architecture may utilize a 3D morphable face model in performing some or all of these functions, as well as and other functions described herein. The 3D facial models generated by the computer vision system may be stored in output files (e.g., FBX files and/or other file types). In some scenarios, the output files can be animation-enabled 3D files that permit users to adjust, customize, and interact with the 3D facial models and corresponding animations.

The technologies described herein provide a variety of benefits and advantages. For example, these technologies enable automated extraction of 3D facial models from 2D electronic media content, which avoids manual processes typically associated with generating 3D content and animations. Additionally, the manner in which the 3D facial models are generated and stored enables users to easily customize and edit digital animations. Additional benefits and advantages are described throughout this disclosure.

The technologies discussed herein can be used in a variety of different contexts and environments. One useful application of these technologies is in the context of digital editing software. For example, the technologies disclosed herein may be integrated into digital editing applications that facilitate creation and/or editing of digital content (e.g., images, videos, animations, etc.). These technologies can be applied to generate and edit digital animations for various industries (e.g., entertainment, film, media, gaming, and/or other industries) and for various purposes (e.g., to create animations for personal usage, advertisements, films, social media, video/computer/mobile games, etc.).

The embodiments described in this disclosure can be combined in various ways. Any aspect or feature that is described for one embodiment can be incorporated to any other embodiment mentioned in this disclosure. Moreover, any of the embodiments described herein may be hardware-based, may be software-based, or, preferably, may comprise a mixture of both hardware and software elements. Thus, while the description herein may describe certain embodiments, features, or components as being implemented in software or hardware, it should be recognized that any embodiment, feature and/or component referenced in this disclosure can be implemented in hardware and/or software.

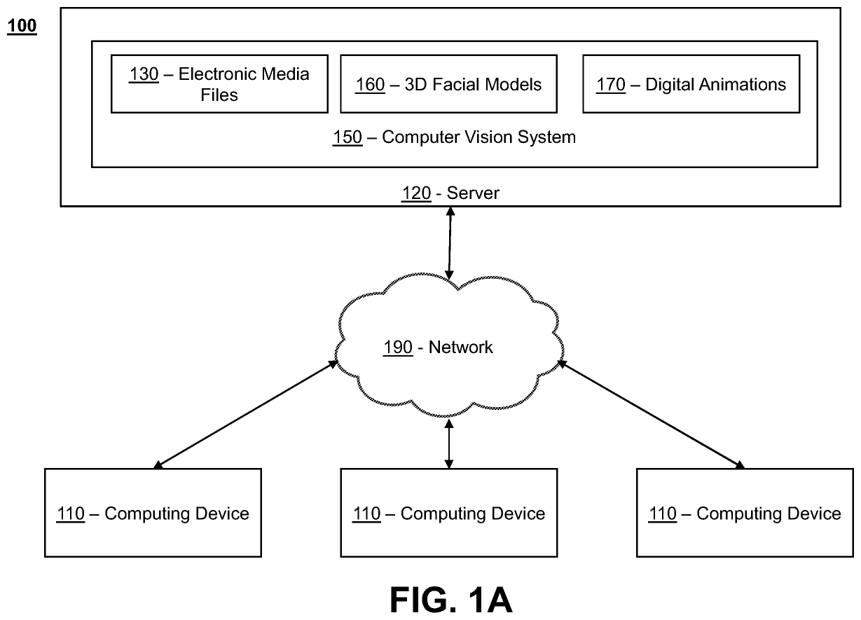

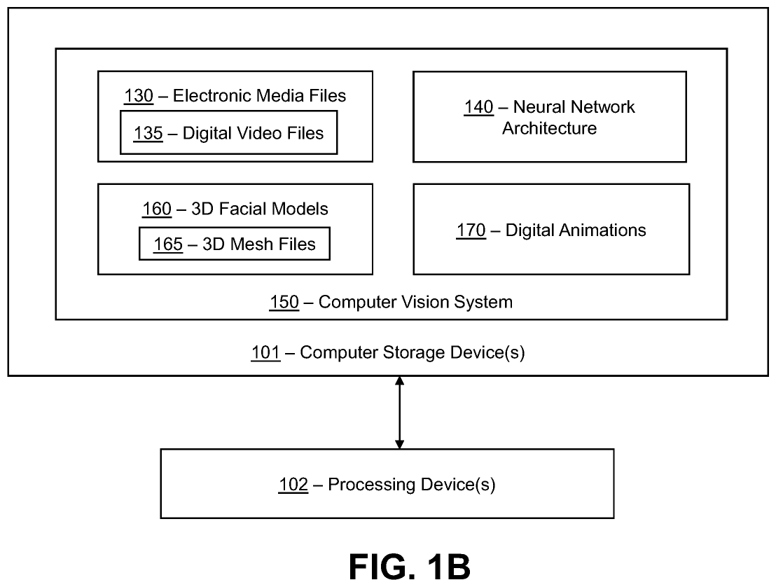

FIG. 1A is a diagram of an exemplary system 100 in accordance with certain embodiments. FIG. 1B is a diagram illustrating exemplary features and/or functions associated with a computer vision system 150.

The system 100 comprises one or more computing devices 110 and one or more servers 120 that are in communication over a network 190. A computer vision system 150 can be stored on, and executed by, the one or more servers 120. The network 190 may represent any type of communication network, e.g., such as one that comprises a local area network (e.g., a Wi-Fi network), a personal area network (e.g., a Bluetooth network), a wide area network, an intranet, the Internet, a cellular network, a television network, and/or other types of networks.

All the components illustrated in FIG. 1A, including the computing devices 110, servers 120, and computer vision system 150, can be configured to communicate directly with each other and/or over the network 190 via wired or wireless communication links, or a combination of the two. Each of the computing devices 110, servers 120, and computer vision system 150 can include one or more communication devices, one or more computer storage devices 101, and one or more processing devices 102 that are capable of executing computer program instructions. The computer storage devices 101 can be physical, non-transitory mediums.

The one or more processing devices 102 may include one or more central processing units (CPUs), one or more microprocessors, one or more microcontrollers, one or more controllers, one or more complex instruction set computing (CISC) microprocessors, one or more reduced instruction set computing (RISC) microprocessors, one or more very long instruction word (VLIW) microprocessors, one or more graphics processor units (GPU), one or more digital signal processors, one or more application specific integrated circuits (ASICs), and/or any other type of processor or processing circuit capable of performing desired functions. The one or more processing devices 102 can be configured to execute any computer program instructions that are stored or included on the one or more computer storage devices 101 including, but not limited to, instructions associated the extracting 3D facial models 160, generating digital animations 170, and/or customizing or editing the 3D facial models 160 and digital animations 170.

The one or more computer storage devices 101 may include (i) non-volatile memory, such as, for example, read only memory (ROM) and/or (ii) volatile memory, such as, for example, random access memory (RAM). The non-volatile memory may be removable and/or non-removable non-volatile memory. Meanwhile, RAM may include dynamic RAM (DRAM), static RAM (SRAM), etc. Further, ROM may include mask-programmed ROM, programmable ROM (PROM), one-time programmable ROM (OTP), erasable programmable read-only memory (EPROM), electrically erasable programmable ROM (EEPROM) (e.g., electrically alterable ROM (EAROM) and/or flash memory), etc. In certain embodiments, the storage devices 101 may be physical, non-transitory mediums. The one or more computer storage devices can store instructions associated with extracting 3D facial models 160 from electronic media files 130, generating digital animations 170 that incorporate the 3D facial models 160, and/or customizing or editing the 3D facial models 160 and digital animations 170.

In certain embodiments, each of the computing devices 110, server(s) 120, and/or computer vision system 150 can additionally include and/or communicate with one or more communication devices. Each of the one or more communication devices can include wired and wireless communication devices and/or interfaces that enable communications using wired and/or wireless communication techniques. Wired and/or wireless communication can be implemented using any one or combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can comprise Bluetooth, Zigbee, Wireless Universal Serial Bus (USB), Z-Wave, etc. Exemplary LAN and/or WAN protocol(s) can comprise Institute of Electrical and Electronic Engineers (IEEE) 802.3 (also known as Ethernet), IEEE 802.11 (also known as WiFi), etc. Exemplary wireless cellular network protocol(s) can comprise Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware can depend on the network topologies and/or protocols implemented. In certain embodiments, exemplary communication hardware can comprise wired communication hardware including, but not limited to, one or more data buses, one or more universal serial buses (USBs), one or more networking cables (e.g., one or more coaxial cables, optical fiber cables, twisted pair cables, and/or other cables). Further exemplary communication hardware can comprise wireless communication hardware including, for example, one or more radio transceivers, one or more infrared transceivers, etc. Additional exemplary communication hardware can comprise one or more networking components (e.g., modulator-demodulator components, gateway components, etc.). In certain embodiments, the one or more communication devices can include one or more transceiver devices, each of which includes a transmitter and a receiver for communicating wirelessly. The one or more communication devices also can include one or more wired ports (e.g., Ethernet ports, USB ports, auxiliary ports, etc.) and related cables and wires (e.g., Ethernet cables, USB cables, auxiliary wires, etc.).

In certain embodiments, the one or more communication devices additionally, or alternatively, can include one or more modem devices, one or more router devices, one or more access points, and/or one or more mobile hot spots. For example, modem devices may enable the computing devices 110, server 120, and/or computer vision system 150 to be connected to the Internet and/or other network 190. The modem devices can permit bi-directional communication between the computing devices 110, server 120, and/or computer vision system 150 and the Internet (and/or other network). In certain embodiments, one or more router devices and/or access points may enable the computing devices 110, server 120, and/or computer vision system 150 to be connected to a LAN and/or other more other networks. In certain embodiments, one or more mobile hot spots may be configured to establish a LAN (e.g., a Wi-Fi network) that is linked to another network (e.g., a cellular network). The mobile hot spot may enable the computing devices 110, server 120, and/or computer vision system 150 to access the Internet and/or other networks.

In certain embodiments, the computing devices 110 may represent desktop computers, laptop computers, mobile devices (e.g., smart phones, personal digital assistants, tablet devices, vehicular computing devices, wearable devices, or any other device that is mobile in nature), and/or other types of devices. The one or more servers 120 may generally represent any type of computing device, including any of the computing devices 110 mentioned above. In certain embodiments, the one or more servers 120 comprise one or more mainframe computing devices that that can execute web servers and can communicate with the computing devices 110 and/or other devices over the network 190 (e.g., over the Internet).

In certain embodiments, the computer vision system 150 can be stored on, and executed by, the one or more servers 120. For example, access to the computer vision system 150 may be provided via a website in some scenarios. Additionally, or alternatively, the computer vision system 150 can be stored on, and executed by, the one or more computing devices 110. The computer vision system 150 can be executed be stored on, and executed, by other devices as well.

In some embodiments, the computer vision system 150 can be stored as a local application on a computing device 110, or integrated with a local application stored on a computing device 110, to implement the techniques and functions described herein. In certain embodiments, the computer vision system 150 can be integrated with (or can communicate with) various applications including, but not limited to, facial recognition applications, digital editing applications, social media applications, and/or other applications that are stored on a computing device 110 and/or a server 120.

In certain embodiments, the one or more computing devices 110 can enable individuals to access the computer vision system 150 over the network 190 (e.g., over the Internet via a web browser application). For example, after a camera device (e.g., which may be directly integrated into a computing device 110 or may be a device that is separate from a computing device 110) has captured or recorded electronic media files 130 (e.g., one or more images and/or one or more videos), an individual can utilize a computing device 110 to transmit the electronic media files 130 over the network 190 to the computer vision system 150. The computer vision system 150 can analyze the electronic media files 130 using the techniques described in this disclosure (e.g., to extract 3D facial models 160 from the electronic media files 130 and generate corresponding digital animations 170). The 3D facial models 160 and/or digital animations 170 generated by the computer vision system 150 can be transmitted over the network 190 to the computing device 110 that transmitted the electronic media files 130 and, if desired, to other computing devices 110.

The computer vision system 150 can be configured to perform any and all operations associated with extracting 3D facial models 160 from electronic media files 130, generating digital animations 170, and/or customizing or editing the 3D facial models 160 and digital animations 170. In certain embodiments, the computer vision system 150 may include a neural network architecture 140 that is configured to perform some or all of these functions.

The electronic media files 130 provided to, and analyzed by, the computer vision system 150 can include any type of image file and/or any type of video file. In certain embodiments, the electronic media files 130 can include one or more 2D images and/or one or more 2D videos. In certain embodiments, the electronic media files 130 may additionally, or alternatively, include one or more three-dimensional (3D) image files or video files. The electronic media files 130 may be captured in any digital or analog format, and using any color space or color model. Exemplary formats can include, but are not limited to, MPEP (Moving Picture Experts Group), JPEG (Joint Photographic Experts Group), WMC (Windows Media Video), AVI (Audio Video Interleave), TIFF (Tagged Image File Format), GIF (Graphics Interchange Format), PNG (Portable Network Graphics), STEP (Standard for the Exchange of Product Data), etc. Exemplary color spaces or models can include, but are not limited to, sRGB (standard Red-Green-Blue), Adobe RGB, gray-scale, etc.

The electronic media files 130 received by the computer vision system 150 can be captured by any type of camera device. The camera devices can include any devices that include an imaging sensor, camera, or optical device. For example, the camera devices may represent still image cameras, video cameras, and/or other devices that include image/video sensors. The camera devices also can include devices that comprise imaging sensors, cameras, or optical devices and which are capable of performing other functions unrelated to capturing images. For example, the camera devices can include mobile devices (e.g., smart phones or cell phones), tablet devices, computing devices, desktop computers, etc. The camera devices can be equipped with analog-to-digital (A/D) converters and/or digital-to-analog (D/A) converters based on the configuration or design of the camera devices. In certain embodiments, the computing devices 110 shown in FIG. 1A can include any of the aforementioned camera devices, and other types of camera devices.

In certain embodiments, some or all of the electronic media files 130 can include one or more facial objects. The facial objects may correspond to faces of individuals captured in images and/or videos. The electronic media files 130 received by the computer vision system 150 can be provided to the neural network architecture 140 for processing and/or analysis.

The structure and configuration of the neural network architecture 140 can vary. In certain embodiments, the neural network architecture can include one or more landmark detection models, one or more edge detection models, one or more segmentation models, one or more 3DMMs (3D morphable models), one or more shape fitting models, and/or other learning models.

In certain embodiments, the neural network architecture 140 (including one or more of the models described herein) can comprise a convolutional neural network (CNN), or a plurality of convolutional neural networks. Each CNN may represent an artificial neural network, and may be configured to analyze images and to execute deep learning functions and/or machine learning functions on the images. Each CNN may include a plurality of layers including, but not limited to, one or more input layers, one or more output layers, one or more convolutional layers (e.g., that include learnable filters), one or more ReLU (rectifier linear unit) layers, one or more pooling layers, one or more fully connected layers, one or more normalization layers, etc. The configuration of the CNNs and their corresponding layers can be configured to enable the CNNs to learn and execute various functions for analyzing, interpreting, and understanding the images, including any of the functions described in this disclosure.

Regardless of its configuration, the neural network architecture 140 can be trained to execute various computer vision functions. For example, in some cases, the neural network architecture 140 execute landmark detection functions, edge detection functions, segmentation functions, and/or object detection functions, each of which may utilized to predict or identify locations and/or shapes of facial objects in the electronic media files 130 (e.g., images or videos). Additionally, or alternatively, the neural network architecture 140 can be configured to execute object classification functions (e.g., which may include predicting or determining whether objects in the electronic media files 130 belong to one or more target semantic classes and/or predicting or determining labels for the objects in the images). The neural network architecture can be trained to perform other types of computer vision functions as well.

The neural network architecture of the computer vision system 150 can be configured to generate and output analysis information based on an analysis of the electronic media files 130. The analysis information for an electronic media file 130 can generally include any information or data associated with analyzing, interpreting, understanding, and/or classifying the electronic media files 130 and/or the objects included in the electronic media files 130. In certain embodiments, the analysis information can include 3D facial models 160, which can comprise information or data that captures 3D facial feature representations that are extracted from 2D content of the input images.

Additionally, or alternatively, the analysis information can include digital animations 170 that incorporate the 3D facial models 160 extracted from the electronic media files 130. In certain embodiments, a digital animation may be generated in which a 3D facial model 160 emulates or mimics a facial object included in a digital video file 135. For example, the pose, expression, orientation, and/or other characteristics of the 3D facial model across frames of the digital animation 170 can be the same or similar to those of the facial object across frames of the digital video file 135. In this manner, the computer vision system 150 can generate a digital animation 170 of a facial object that corresponds directly to the digital video file 135.

Additionally, or alternatively, the analysis information can include one or more 3D mesh files 165 that define the representations of the 3D facial objects 160 extracted from the 2D content of electronic media files 130. In scenarios where an electronic media file 130 being processed by the computer vision system 150 comprises a digital video file 135, a separate 3D mesh file 165 can be generated for each frame of the digital video file 135. In some cases, each mesh file 165 can include reference points in the x, y, and z axes to define the height, width, shape and other features of a 3D facial model 160. In scenarios where an electronic media file 130 being processed by the computer vision system 150 comprises a single digital image, the computer vision system 150 may output a single mesh file 165 corresponding to the image.

The digital animations 170 and/or mesh files 165 generated by the computer vision system 150 can be utilized by digital artists, developers, and/or other users to create facial animations and/or other digital content. In some scenarios, the computer vision system 150 also can provide functions or features that enable these individuals modify and edit the digital animations 170 and/or mesh files 165 to create content for various purposes (e.g., for personal usage, advertisements, films, social media, video/computer/mobile games, etc.).

In certain embodiments, one or more training procedures may be executed to train the neural network architecture 140 (or learning models included therein) to perform the functions described in this disclosure. The training procedures can enable the neural network architecture 140 to learn functions for accurately extracting 3D facial models 160 and generating digital animations 170 corresponding to the electronic media files 130. The specific procedures that are utilized to train the neural network architecture 140 can vary. In some cases, one more supervised training procedures, one or more unsupervised training procedures, and/or one or more semi-supervised training procedures may be applied to train the neural network architecture 140, or certain portions of the neural network architecture 140.

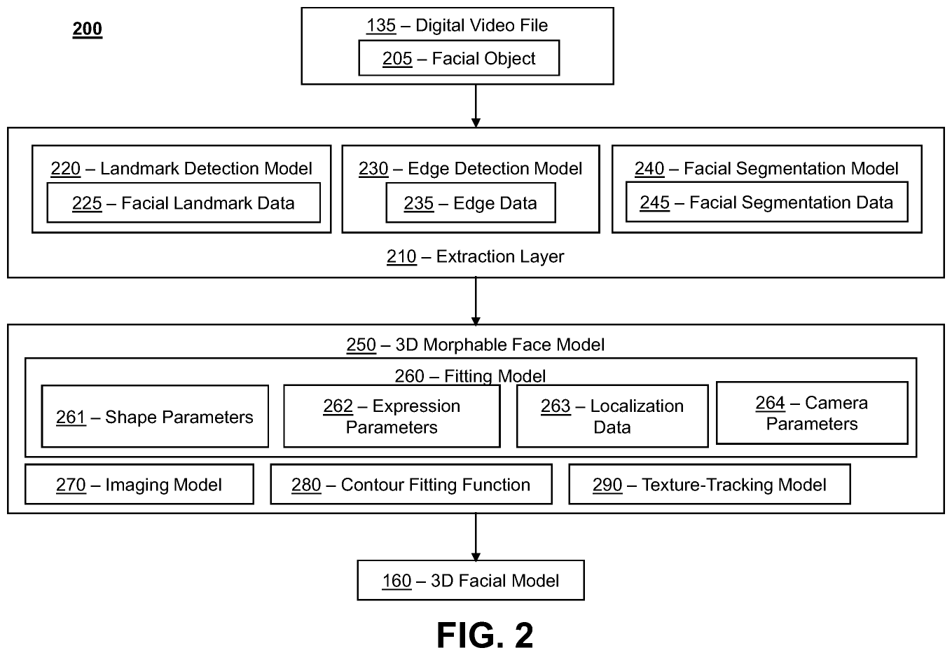

FIG. 2 is a block diagram illustrating an exemplary configuration 200 (and process flow) for a computer vision system 150 according to certain embodiments.

The computer vision system 150 may receive an electronic media file 130, such as a digital video file 135. In some cases, the digital video file 135 comprises a monocular video captured by a single camera device. The content of the digital video file 135 can comprise footage that captures at least one facial object 205 corresponding to a face of an individual.

The digital video file 135 may initially be processed by an extraction layer 210 of the computer vision system 150 (or neural network architecture 140 associated with the computer vision system 150), which is configured to extract and/or derive various types data for the facial objects 205 included in the digital video file 135. In certain embodiments, the extraction layer 210 may include a landmark detection model 220, an edge detection model 230, and a facial segmentation model 240, each of which separately processes the digital video file 135 to extract information.

The landmark detection model 220 can be configured to analyze the digital video file 135 and extract facial landmark data 225 associated with the digital video file 135. For example, for each facial object 205 captured in the digital video file 135, the landmark detection model 220 can extract facial landmark data 225 that identifies or predicts key points of a human face (e.g., eyes, lips, nose, etc.). This facial landmark data 225 can be extracted for some or all of the frames or images included in the digital video file 135. The number of facial points identified for each facial object 205 can vary, but, in some cases, may include 68 or 468 landmark points. Various architectures can be utilized to execute the functions associated with the landmark detection model 220. In certain embodiments, the landmark detection model 220 can be implemented using one or more of the following architectures: MediaPipe, Opencv, and/or FAN (Face Alignment Network). Other architectures also may be utilized. In some cases, the aforementioned architectures and/or other architectures may be pre-trained to facilitate extraction of the facial landmark data 225 from the digital video file 135.

The edge detection model 230 can be configured to analyze the digital video file 135 and extract edge data 235 for each facial object 205 captured in the digital video file 135. The edge data 235 may include data or information that identifies or predicts locations of edges corresponding to facial features (e.g., edges of the face itself, as well as edges corresponding to nose, lips, eyes and other facial features) for each of the facial objects 205. This edge data 235 can be extracted for some or all of the frames or images included in the digital video file 135. Various architectures can be utilized to execute the functions associated with the edge detection model 230 including, but not limited to, various CNN-based architectures. In certain embodiments, the edge detection model 230 can be implemented using one or more of the following architectures: Canny edge detector and/or Sobel edge detector (sometimes referred to as the Sobel-Feldman edge detector). Other architectures also may be utilized. In some cases, the aforementioned architectures and/or other architectures may be pre-trained to facilitate extraction of the edge data 235 from the digital video file 135.

The facial segmentation model 240 can be configured to analyze the digital video file 135 and extract facial segmentation data 235 for each facial object 205 captured in the digital video file 135. For each facial object 205, the facial segmentation data 235 can include a mask or other data that identifies or predicts the precise location of the facial object 205 (e.g., a mask that predicts the boundary of the facial object 205 with pixel-level accuracy). This facial segmentation data 245 can be extracted for some or all of the frames or images included in the digital video file 135. Various architectures can be utilized to execute the functions associated with the facial segmentation model 240 including, but not limited to, various CNN-based architectures. In certain embodiments, the facial segmentation model 240 can be implemented using one or more of the following architectures: Face Toolbox, FaceNet, and/or BiSeNet. Other architectures also may be utilized. In some cases, the aforementioned architectures and/or other architectures may be pre-trained to facilitate extraction of the facial segmentation data 235 from the digital video file 135.

The information extracted by the extraction layer 210 (including the facial landmark data 225, edge data 235, and facial segmentation data 245) can be provided to a 3D morphable face model 250 (3DMM), which can utilize this information to generate one or more 3D facial models 160 for each facial object 205 included in the digital video file 245.

In certain embodiments, the 3D morphable face model 250 can include, inter alia, a fitting model 260, an imaging model 270, a contour fitting function 280, and a texture tracking model 290. For the purposes of this disclosure, these components (e.g., fitting model 260, imaging model 270, contour fitting function 280, and texture tracking model 290) may be described as being integrated with the 3D morphable face model 250, but it should be recognized that one or more of these components can be separated from the 3D morphable face model 250. In the case of the latter, the 3D morphable face model 250 may utilize the values and data derived by these components to generate the 3D facial models 160.

The 3D morphable face model 250 can execute functions associated with transforming each of the (two-dimensional) facial objects 205 captured in the digital video file 135 into a 3D facial model 160. In certain embodiments, the 3D morphable face model 250 can execute an improved fitting model 260 that is adapted to generate or construct a 3D facial model 160 for each facial object 205 in a manner that accurately captures the facial shape, facial expression, texture, appearance, pose, and other attributes of the corresponding facial object 205.

The fitting model 260 described herein overcomes several technical challenges associated with constructing 3D facial models 160 from 2D image content. Estimating 3D shape and animation of faces from a monocular video is a longstanding problem in computer vision. Some of technical challenges can be attributed to accurately performing facial shape estimation, facial expression tracking, and face localization tasks. With respect to performing facial shape estimation, a statistical model of 3D face shape may be used to parameterize the non-rigid facial components, which transforms the problem of shape estimation to one of model fitting and provides a strong statistical prior to constrain the problem. However, in many cases, this is not enough to constrain the model using a single frame. Using multiple frames can provide additional information about the facial shape, but other parameters, such as like facial expression, may change drastically across frames. Consequently, this is a highly non-linear problem.

Moreover, while landmark data and edge information can be to estimate facial shape, expression and position data for a single frame, the landmark and edges information generated by standard methods is often flawed, and these methods breakdown when the input data is noisy and/or when the shape estimates are used on different frames of the video. To overcome these challenges, the fitting model 260 described herein can execute an algorithm that uses the all of the video frames (or a subset of useful video frames) to perform 3D facial reconstruction for facial objects 205 captured in a digital video file 235.

Additional challenges associated with performing 3D facial reconstruction can be attributed to perspective projection, which also is a highly non-linear problem due to conversion between homogeneous and non-homogeneous coordinate systems and ambiguities between focal length and distance of the individual from the camera.

To achieve superior results for 3D facial reconstruction, the 3D morphable face model 250 can utilize an imaging model 270 with perspective projection in combination with the fitting model 260. The fitting model 260 can comprise an iterative algorithm that is able to generate or derive, inter alia, the following data for each facial object 205 in a given digital video file 135:
1) Shape Parameters 261: The fitting model 260 can be used to derive a single set of shape parameters 261 for an individual or facial object 105 across the entirety of the digital video file. The shape parameters 261 can generally include any data that defines the shape of face itself (e.g., outer perimeter or contours of the face) and/or features of a face (e.g., nose, mouth, lips, eyes, cheeks, chin, and other facial features).
2) Expression Parameters 262: The fitting model 260 can be used to derive a set of expression parameters 262 in each frame of the digital video file 135 (or in a subset of useful frames) that collectively define the facial expressions of a facial object 205 across the digital video file 135. Across the frames of the digital video file 145, the features of facial object 205 (e.g., mouth, lips, eyes, cheeks, forehead, etc.) can differ in appearance based on varying facial expressions, and these varying facial expressions can be captured by the expression parameters 262 and correlated with corresponding frames.
3) Localization Data 263: The fitting model 260 can be used to derive a set of localization data for each frame of the digital video file 135 (or for a subset of useful frames) that determines the precise location of the facial object 205 in each frame. Across the frames of the digital video file 145, the location of facial object 205 can move or vary and the locations of the facial object 205 can be captured by the localization data 263 and correlated with corresponding frames.
4) Camera Parameters 264: The fitting model 260 and/or imaging model 270 can be used to derive an estimate of a probable set of perspective camera parameters that identify the position, orientation, and/or camera pose of a camera that captured the digital video file 135 in a 3D space or 3D coordinate system. The camera parameters 264 also include similar information about individual or facial objects 205 captured the digital video file 135. For example, in some embodiments, the camera parameters 264 can include some or all of the following: a) data identifying a specific perspective or camera pose of a camera in a 3D space or coordinate system; b) data identifying a specific location, orientation, and/or position of each an individual or facial object 205 in the same 3D space or coordinate system; c) data identifying a distance between the camera and each of the individuals or facial objects 205 in 3D space or coordinate system; and d) the focal length of the camera that captured the digital video file 135.

The aforementioned parameters and data derived by fitting model 260 and/or imaging model 270 can be utilized by the 3D morphable face model 250 to accurately generate or output one or more 3D facial models 160 from each digital video file 135. In some cases, each 3D facial model 160 can comprise a set of mesh files 165, each of which corresponds to particular frame of the digital video file 135 (or a subset of frames from the digital video file 135).

As explained in further detail below, the fitting model 260 executed by the 3D morphable face model 250 can comprise a multi-step algorithm that is executed to derive the aforementioned parameters and data and generate the 3D facial models 160. This multi-step algorithm can include: 1) estimating a camera pose for the camera that captured a digital video file 135; 2) perform shape fitting on a target facial object 205 included in the digital video file 135; 3) perform expression fitting on the target facial object 205; 4) post-process the fitting model data after all the shape, expression and camera pose values have converged; and 5) generate a 3D facial model 160 comprising a plurality of mesh files across frames of the digital video file 135. Exemplary techniques for performing each of these steps is described in greater detail below.

To fit the 3D morphable face model 250 to the 2D content of the digital video file 160, the imaging model 270 (or camera model) can be used to project the 3D facial model into the 2D space 160. In some cases, an imaging model 270 can include or utilize a perspective camera (or perspective projection) for this operation. Using the projection of the imaging model 270, the fitting model 260 (or other component of the 3D morphable face model 250) can be utilized to generate or derive the camera parameters 264 mentioned above.

Notably, usage of a perspective camera or perspective projection introduces non-linearity by presenting an additional parameter—i.e., focal length—because there is ambiguity among the focal length, z-coordinates of a vertex, and the shape. Through our series of trials to estimate the camera parameters 264, it was discovered that the camera center can be recovered independently of the focal length. Since in perspective projection the same image can be created multiple times with different combinations of focal length and depth value, it can be beneficial to fix or define the depth value manually and by running a Gauss-Newton optimizer. This technique can be used to estimate the focal length of the camera, thus removing the ambiguity. The estimated camera pose (e.g., describing the position and orientation of the camera) can then be derived.

Given the estimated camera pose, the fitting model 260 can then execute functions for performing shape and expression fitting on the digital video file 135 and generating corresponding shape parameters 261 and expression parameters 262. In certain embodiments, the shape fitting functions may initially use the facial landmark data 225 derived by the extraction layer 210 to generate preliminary or sparse shape parameters 261 for a facial object 205, and the edge data 235 and facial segmentation data 245 can then be utilized to refine or optimize the shape parameters to more accurately reflect the shape of the facial object 205. In certain embodiments, a Gauss-Newton optimizer can be utilized to refine or accurately estimate the shape parameters 261 of the 3D facial model 160. This optimizer can be configured to morph or adapt the 3D facial model 160 based on processing a plurality of images or frames obtained from the digital video file 135.

Next, the fitting algorithm 260 can then execute expression fitting functions to estimate the expression parameters 262 using the same set of images that were processed in the shape fitting operations. In doing so, the fitting algorithm 260 can leverage or utilize the camera parameters 264 (e.g., identifying the camera pose) and shape parameters 261 to obtain values for various blendshapes (or other similar morph targets), which can be used to define and adjust facial expressions and facial poses for the 3D facial model 160 across the frames of the digital video file 135. In addition to modeling facial expressions, another advantage of using blendshapes is that blendshape fitting also can be used to remove a facial expression from a subject, or to re-render it with a different expression.

In certain embodiments, the fitting model 260 performs shape and expression fitting on a bilinear system comprising unknown shape and expression coefficients, which can be solved efficiently by keeping one of the coefficients fixed and estimating the value of the other. In some cases, an extra regularization term can be utilized by the fitting model 260 to keep the model from drastically changing as the convergence criteria is forced.

Next, after the shape, expression, and camera pose values have converged to produce an accurate representation of the facial object, a post-processing operation can be executed to further enhance facial contours of the 3D facial model 160. In certain scenarios, testing demonstrated that the outer face contours present in the 2D image content do not accurately correspond to the contours on the 3D facial model 160. These contours can be important for an accurate facial reconstruction, as they define the boundary region of the facial object.

To deal with this problem of contour correspondences, the fitting model 260 can execute a contour fitting function 280 that utilizes hard edge correspondence technique. In some cases, the contour fitting function 280 can be configured to separately refine the front-facing and the back-facing contours.

Given a current pose estimate, the 2D contour can be separated into the front-facing contours and the back-facing, occluding edge contours. The front-facing face contours can be fit by using semi-fixed 2D-3D correspondences from a list of candidate points along the mesh outline. A set of vertices V along the outline of the 3D face model are defined, which we obtain using a segmentation mask of the face (e.g., form the facial segmentation data 245 obtained by the extraction layer 210). Given an initial fit, the contour fitting function 280 then searches for the closest vertex in that list for each detected 2D contour point. Using a whole set of potential 3D contour vertices renders the method robust against varying roll and pitch angles. It also makes the method robust against vertical inaccuracies of the contour from the landmark regressor, since the contour landmarks of 2D landmark regressors are usually not clearly defined. Once found, these contour correspondences are then used as additional corresponding points in the subsequent fitting steps.

To deal with occluding contours, the contour fitting function 280 generates a set of all possible occluding edge vertices with the current shape and expression fitting estimates. Employing the use of the z-buffer algorithm, the contour fitting function 280 identifies these occluding vertices, which can be performed using ray-casting from the camera origin to each vertex. Self-occluding vertices are removed as well. The contour fitting function 280 then identifies the closest occluding edge vertex from the list of all computed occluding edge vertices by building a k-d tree of the occluding edge vertices. The new correspondences obtained can then be used in subsequent fitting steps.

The entire optimization algorithm executed by the fitting function 260 can then be re-run again using the original correspondences, the new correspondences, the shape parameters, the expression parameters and the pose parameters as inputs. The output of the optimization algorithm in this second pass can be used to obtain final values for 3D facial model 160, including the shape parameters 261, expression parameters 262, localization data 263, camera parameters 264, and contour parameters.

The 3D morphable face model 250 can generate the final 3D facial model 160 for a facial object 205 captured in the digital video file 135 using final values of these parameters. In some embodiments, the 3D facial model 160 can comprise a set of mesh files 165 for each frame of the digital video file 135. In certain embodiments, the 3D facial model 160 can be incorporated into, or utilized to create, a digital animation 170 as described above.

In certain embodiments, the fitting model 160 and/or 3D morphable face model 250 can be enhanced using a texture-tracking model 290, which can optimize the color or illumination parameters for the 3D facial models 160.

In many cases, additional technical problems in generating a 3D facial 160 model can be attributed to moving 3D vertices, or jitters, in the final values produced by the fitting model 160, which can result from minute inaccuracies in the tracking of the output. This can often arises with models that attempt to incorporate pixel-accurate tracking. To address this problem, the texture-tracking model 290 can refine the outputs of the fitting model 160 before those outputs are used by the 3D morphable face model 250 to generate a 3D facial model 160.

In a broad sense, the texture-tracking model 290 monitors or tracks the movement of specific pixels in 2D over the course of the digital video file 135, and utilizes that information to incorporate corrections in the 3D output frame-by-frame, thereby reducing jitters and improving the overall accuracy. The texture-tracking model 290 can perform this operation multiple times in an iterative manner to mitigate the impact of bad tracks, and to maximize the improvements made.

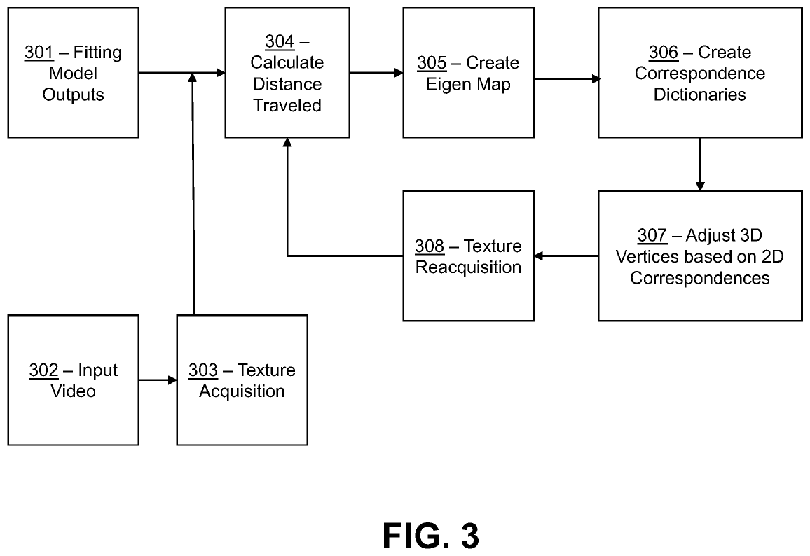

FIG. 3 is a flow diagram illustrating an exemplary process 300 and for a texture-tracking model 290 according to certain embodiments. The texture-tracking model 290 initially receives a digital video file 135 and the outputs of the fitting model 160, which can include the shape parameters 261, expression parameters 262, localization data 263, camera parameters 264, and contour parameters described above (blocks 301 and 302). A texture acquisition function processes the digital video file 135 (block 303). Using that output, the texture-tracking model 290 selects a number of pixels in a uniform manner that will be tracked for the entirety of the digital video file 135. For each selected pixel, the texture-tracking model 290 calculates the amount that it moves across each frame of the digital video file 135 (block 304), and saves that information using an abstraction, which can be referred to as an Eigen map (block 305). In some embodiments, the distance values can be calculated using a dense optical flow algorithm.

The Eigen map may represent an image smaller than the video frames, which records the movement of each tracked pixel in the image via RGB color values. The image may start as a baseline gray image, and any pixels that have moved can be adjusted from that gray. The RGB values can represent the axes of the image. Since the original 2D image is being analyzed, the texture-tracking model 290 only modifies the x and y axes (and the z axis, or blue channel, will not be adjusted). The map is able to be smaller than the original image because we only track a select number of pixels rather than the whole frame.

Moreover, because movement or distance tracking is only performing on a select number of pixels (and also because not all of those pixels are moving), the Eigen map can start as a very sparse representation of movement in the image. It is apparent that when one pixel moves, there will also be some inherent effect on its nearby neighbors. Consequently, the map must be adjusted to be accurate. To accomplish this, the texture-tracking model 290 can execute a diffusion operation which spreads the color of pixels to others nearby in a linear manner. The radius used to choose which pixels are “nearby” can be manually defined and adjustable.

This diffused Eigen map can then used to transform the 3D vertices included in the output of the fitting model 260. In certain embodiments, this can be performed by naively applying the distances to the 3D vertices. One of the technical difficulties encountered in this scenario relates to accounting for the tilt or position of the face in the 3D space. To account for these factors, the texture-tracking model 290 can be configured with functions that identify the correct 2D-to-3D correspondences, and determine how to move the vertices once they are found.

To find the correspondences, one or more dictionaries can be created using information from various inputs that can be generated by the texture-tracking model 290 (block 306). A first input tracks the correspondence between the indices of 2D pixels and the indices of 3D vertices. For a second input, the keys include the indices of the colored 2D pixels, and the values were the indices of the neighbors of those pixels. A third input can include the keys as the color values of the 2D pixels and the values as their 2D indices. Using this information, the texture-tracking model 290 can then accurately identify the correct vertices in 3D and their neighbors.

Several factors should be accounted for in determining how to move the vertices and apply the distance values from the Eigen map. A primary factor relates to maintaining the proportional distance between pixels in the 2D space and the pixels in the 3D space. This means that the neighbors of moved pixels also needed to be proportionally moved.

In some embodiments, due to the iterative nature of the texture tracking process, it can be beneficial only to move the vertices by a fractional value of the originally recorded distance traveled. By choosing only to use part of the distance, this can prevent the texture-tracking model 290 from being overly influenced by noisy or inaccurate distance values. Because the distance is recalculated on each future iteration, any incorrect movements can be found and fixed before they adjust the output by their full magnitude.

With the previous two criteria accounted for, the texture-tracking model 290 is able to move the 3D vertices appropriately for all of the pixels in the Eigen map (block 307). After this has been done, the current iteration can be considered complete. There will be visibly significant improvement in the 3D output even after a single iteration. Additional iterations can utilize a texture reacquisition module (block 308) on this output, at which point the whole process can be repeated again.

The number of iterations can be arbitrary, but the output will eventually converge to a point when further iterations are not necessary. The final result after convergence is a more accurate and more stable 3D facial model 160. Particularly this helps to reduce jitters and vertex movement between frames in the 3D space.

This process of obtaining the texture map from a 2D video input can be referred to as “texture acquisition,” while the process for obtaining a texture map from a 3D facial model output can be referred to as “texture reacquisition.” The two processes are heavily linked, but with some core differences between them. The description below provides further details on the initial texture acquisition process and the subsequent texture reacquisition process utilized by the texture-tracking model 290.

With respect to the initial texture acquisition phase, the texture-tracking model 290 is capable of extracting UV texture maps both from 2D video inputs and from its own 3D outputs. Generally speaking, each of the UV maps may generally represent a flattened out 2D image representation of a 3D facial model 160, and they can be useful for representing the texture of a 3D object. The texture acquisition module can be configured to construct one of these maps from a 2D image using some of the same methods, data and ideas as the fitting model 260. Particularly, in addition to receiving the 2D image as input, the texture acquisition module can use the same shape parameters 261, expression parameters 262, and camera parameters 263 as the fitting model 260.

The creation of a UV map also requires information on the lighting in the image. This is because visible color of an object is determined by two sets of values: the true color of the object (albedo), and the characteristics of the light that is shining upon it. If it is not already available, the lighting information is able to be fitted within the texture acquisition module itself.

To do so, an optimization procedure can be executed that relies on an initial estimate for albedo, and a good neutral baseline for lighting. The texture acquisition module can then alternate optimization of the lighting and albedo until a convergence is reached for both using an MSE (mean squared error) loss function.

Once the lighting file is prepared (or if it was provided as input), the creation of the UV maps can begin. As part of the process, a UV map can be created for each frame of the video, along with an “average” map that seeks to provide the best possible general representation of the face. This can be useful because in many frames there is some portion of the face that is occluded. These points cannot be represented in the UV map because the information is missing. However, because those points will likely be visible in at least one frame, the average map can covers all points that were visible in at least one frame. This allows us to holistically represent the video with a single image.

The UV maps that are constructed can come in two forms: one is a combined albedo and lighting, and the other has separated out the lighting (thus, only showing the albedo). The combined image is designed to be true to what is seen when looking at the video, while the latter tries to show the true color of the face. Both are useful in different contexts and, therefore, are included as part of the output.

The texture-tracking model 290 also can include a function or module that fills in the “holes” in the map where the face was occluded. The holes can be filled using a custom interpolation method to spread nearby color. This allows us to get a full picture for any individual frame when that is desirable over the average.

Moving on, texture reacquisition functions in a very similar manner to the initial texture acquisition. It is referred to as “reacquisition” because it is applied after a video has already been fully processed (and, because of that processing, the UV maps have now changed). The main differences between the acquisition and reacquisition modules are primarily in relation to the inputs. Rather than using the same shape parameters 261, expression parameters 262, and camera parameters 263 that were used by the texture acquisition module, the texture reacquisition module receives a series of object files (e.g., .OBJ files) which represent each frame. It also assumes that a lighting file is being provided rather than fitting a new one. Aside from the inputs, the same process described above for the texture acquisition module with respect to creating new UV maps for each frame and an average map for the video can be executed by the texture reacquisition module.

In certain embodiments, a method is implemented for generating a three-dimensional (3D) facial model from two-dimensional (2D) electronic media files via execution of computing instructions by one or more processing devices and stored on one or more non-transitory computer-readable media. The method comprises: (a) receiving, at a computer vision system, an electronic video file comprising 2D video content; (b) extracting, using an extraction layer of the computer vision system, facial object data corresponding to a facial object captured in the electronic video file, the facial object data at least comprising facial landmark data, edge data, and facial segmentation data corresponding to the at least one facial object; (c) executing a fitting model configured to: (i) derive shape parameters for the facial object based, at least in part, on an analysis of the facial object data extracted across multiple frames of the electronic video file; (ii) derive expression parameters corresponding to the facial object for each of the multiple frames of the electronic video file; (iii) derive localization data for the facial object that determines a location of the facial object in each of the multiple frames of the electronic video file; and (iv) derive camera parameters indicating a position, an orientation, and a camera pose for a camera that captured in the electronic video file and the facial object; (d) generating, using a 3D morphable face model of the computer vision system, a 3D facial model corresponding to the facial object based, at least in part on, the shape parameters, the expression parameters, the localization data, and the camera parameters derived by the fitting model.

In certain embodiments, a system is disclosed for generating a three-dimensional (3D) facial model from two-dimensional (2D) electronic media files, and the system includes one or more computing devices comprising one or more processing devices and one or more non-transitory storage devices that store instructions. Execution of the instructions by the one or more processing devices causes the one or more computing devices to: (a) receive, at a computer vision system, an electronic video file comprising 2D video content; (b) extract, using an extraction layer of the computer vision system, facial object data corresponding to a facial object captured in the electronic video file, the facial object data at least comprising facial landmark data, edge data, and facial segmentation data corresponding to the at least one facial object; (c) execute a fitting model configured to: (i) derive shape parameters for the facial object based, at least in part, on an analysis of the facial object data extracted across multiple frames of the electronic video file; (ii) derive expression parameters corresponding to the facial object for each of the multiple frames of the electronic video file; (iii) derive localization data for the facial object that determines a location of the facial object in each of the multiple frames of the electronic video file; and (iv) derive camera parameters indicating a position, an orientation, and a camera pose for a camera that captured in the electronic video file and the facial object; (d) generate, using a 3D morphable face model of the computer vision system, a 3D facial model corresponding to the facial object based, at least in part on, the shape parameters, the expression parameters, the localization data, and the camera parameters derived by the fitting model.

In certain embodiments, a computer program product is disclosed comprising a non-transitory computer-readable medium including instructions for causing a computing device to: (a) receive, at a computer vision system, an electronic video file comprising two-dimensional (2D) video content; (b) extract, using an extraction layer of the computer vision system, facial object data corresponding to a facial object captured in the electronic video file, the facial object data at least comprising facial landmark data, edge data, and facial segmentation data corresponding to the at least one facial object; (c) execute a fitting model configured to: (i) derive shape parameters for the facial object based, at least in part, on an analysis of the facial object data extracted across multiple frames of the electronic video file; (ii) derive expression parameters corresponding to the facial object for each of the multiple frames of the electronic video file; (iii) derive localization data for the facial object that determines a location of the facial object in each of the multiple frames of the electronic video file; and (iv) derive camera parameters indicating a position, an orientation, and a camera pose for a camera that captured in the electronic video file and the facial object; and (d) generate, using a three-dimensional (3D) morphable face model of the computer vision system, a 3D facial model corresponding to the facial object based, at least in part on, the shape parameters, the expression parameters, the localization data, and the camera parameters derived by the fitting model.

Embodiments may include a computer program product accessible from a computer-usable or computer-readable medium providing program code for use by or in connection with a computer or any instruction execution system. A computer-usable or computer-readable medium may include any apparatus that stores, communicates, propagates, or transports the program for use by or in connection with the instruction execution system, apparatus, or device. The medium can be a magnetic, optical, electronic, electromagnetic, infrared, or semiconductor system (or apparatus or device) or a propagation medium. The medium may include a computer-readable storage medium, such as a semiconductor or solid-state memory, magnetic tape, a removable computer diskette, a random access memory (RAM), a read-only memory (ROM), a rigid magnetic disk and an optical disk, etc.

A data processing system suitable for storing and/or executing program code may include at least one processor coupled directly or indirectly to memory elements through a system bus. The memory elements can include local memory employed during actual execution of the program code, bulk storage, and cache memories that provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modems, and Ethernet cards are just a few of the currently available types of network adapters.

It should be recognized that any features and/or functionalities described for an embodiment in this application can be incorporated into any other embodiment mentioned in this disclosure. Moreover, the embodiments described in this disclosure can be combined in various ways. Additionally, while the description herein may describe certain embodiments, features, or components as being implemented in software or hardware, it should be recognized that any embodiment, feature, or component that is described in the present application may be implemented in hardware, software, or a combination of the two.

While various novel features of the invention have been shown, described, and pointed out as applied to particular embodiments thereof, it should be understood that various omissions and substitutions, and changes in the form and details of the systems and methods described and illustrated, may be made by those skilled in the art without departing from the spirit of the invention. Amongst other things, the steps in the methods may be carried out in different orders in many cases where such may be appropriate. Those skilled in the art will recognize, based on the above disclosure and an understanding of the teachings of the invention, that the particular hardware and devices that are part of the system described herein, and the general functionality provided by and incorporated therein, may vary in different embodiments of the invention. Accordingly, the description of system components are for illustrative purposes to facilitate a full and complete understanding and appreciation of the various aspects and functionality of particular embodiments of the invention as realized in system and method embodiments thereof. Those skilled in the art will appreciate that the invention can be practiced in other than the described embodiments, which are presented for purposes of illustration and not limitation. Variations, modifications, and other implementations of what is described herein may occur to those of ordinary skill in the art without departing from the spirit and scope of the present invention and its claims.

1. A method implemented for generating a three-dimensional (3D) facial model from two-dimensional (2D) electronic media files via execution of computing instructions by one or more processing devices and stored on one or more non-transitory computer-readable media, the method comprising:
receiving, at a computer vision system, an electronic video file comprising 2D video content;
extracting, using an extraction layer of the computer vision system, facial object data corresponding to a facial object captured in the electronic video file, the facial object data at least comprising facial landmark data, edge data, and facial segmentation data corresponding to the at least one facial object;
executing a fitting model configured to:
derive shape parameters for the facial object based, at least in part, on an analysis of the facial object data extracted across multiple frames of the electronic video file;
derive expression parameters corresponding to the facial object for each of the multiple frames of the electronic video file;
derive localization data for the facial object that determines a location of the facial object in each of the multiple frames of the electronic video file; and
derive camera parameters indicating a position, an orientation, and a camera pose for a camera that captured in the electronic video file and the facial object;
generating, using a 3D morphable face model of the computer vision system, a 3D facial model corresponding to the facial object based, at least in part on, the shape parameters, the expression parameters, the localization data, and the camera parameters derived by the fitting model.

2. The method of claim 1, wherein generating the 3D facial model includes generating one or more mesh files that define a representation of the 3D facial model across the multiple frames of the electronic video file.

3. The method of claim 2, wherein the 3D facial model captured in the one or more mesh files mimics a facial shape, facial expression, appearance, and pose of the facial object in a 3D environment.

4. The method of claim 1, wherein deriving the camera parameters further comprises deriving a focal length of the camera, and utilizing the focal length to derive the camera pose.

5. The method of claim 1, wherein extracting the facial object data by the extraction layer of the computer vision system includes:
executing a landmark detection model to extract the facial landmark data corresponding to the facial object across the multiple frames of the electronic video file;
executing an edge detection model to extract the edge data corresponding to the facial object across the multiple frames of the electronic video file; and
executing a facial segmentation model to extract the facial segmentation data corresponding to the facial object across the multiple frames of the electronic video file.

6. The method of claim 1, wherein generating the 3D facial model includes executing a post-processing operations that utilizes a contour fitting function configured to enhance facial contours of the 3D facial model.

7. A system for generating a three-dimensional (3D) facial model from two-dimensional (2D) electronic media files, wherein the system includes one or more computing devices comprising one or more processing devices and one or more non-transitory storage devices that store instructions, wherein execution of the instructions by the one or more processing devices causes the one or more computing devices to:
receive, at a computer vision system, an electronic video file comprising 2D video content;
extract, using an extraction layer of the computer vision system, facial object data corresponding to a facial object captured in the electronic video file, the facial object data at least comprising facial landmark data, edge data, and facial segmentation data corresponding to the at least one facial object;
execute a fitting model configured to:
derive shape parameters for the facial object based, at least in part, on an analysis of the facial object data extracted across multiple frames of the electronic video file;
derive expression parameters corresponding to the facial object for each of the multiple frames of the electronic video file;
derive localization data for the facial object that determines a location of the facial object in each of the multiple frames of the electronic video file; and
derive camera parameters indicating a position, an orientation, and a camera pose for a camera that captured in the electronic video file and the facial object;
generate, using a 3D morphable face model of the computer vision system, a 3D facial model corresponding to the facial object based, at least in part on, the shape parameters, the expression parameters, the localization data, and the camera parameters derived by the fitting model.

8. The system of claim 7, wherein generating the 3D facial model includes generating one or more mesh files that define a representation of the 3D facial model across the multiple frames of the electronic video file.

9. The system of claim 8, wherein the 3D facial model captured in the one or more mesh files mimics a facial shape, facial expression, appearance, and pose of the facial object in a 3D environment.

10. The system of claim 7, wherein deriving the camera parameters further comprises deriving a focal length of the camera, and utilizing the focal length to derive the camera pose.

11. The system of claim 7, wherein extracting the facial object data by the extraction layer of the computer vision system includes:
executing a landmark detection model to extract the facial landmark data corresponding to the facial object across the multiple frames of the electronic video file;
executing an edge detection model to extract the edge data corresponding to the facial object across the multiple frames of the electronic video file; and
executing a facial segmentation model to extract the facial segmentation data corresponding to the facial object across the multiple frames of the electronic video file.

12. The system of claim 7, wherein generating the 3D facial model includes executing a post-processing operations that utilizes a contour fitting function configured to enhance facial contours of the 3D facial model.

13. A computer program product, the computer program product comprising a non-transitory computer-readable medium including instructions for causing a computing device to:
receive, at a computer vision system, an electronic video file comprising two-dimensional (2D) video content;
extract, using an extraction layer of the computer vision system, facial object data corresponding to a facial object captured in the electronic video file, the facial object data at least comprising facial landmark data, edge data, and facial segmentation data corresponding to the at least one facial object;
execute a fitting model configured to:
derive shape parameters for the facial object based, at least in part, on an analysis of the facial object data extracted across multiple frames of the electronic video file;
derive expression parameters corresponding to the facial object for each of the multiple frames of the electronic video file;
derive localization data for the facial object that determines a location of the facial object in each of the multiple frames of the electronic video file; and
derive camera parameters indicating a position, an orientation, and a camera pose for a camera that captured in the electronic video file and the facial object;
generate, using a three-dimensional (3D) morphable face model of the computer vision system, a 3D facial model corresponding to the facial object based, at least in part on, the shape parameters, the expression parameters, the localization data, and the camera parameters derived by the fitting model.

14. The computer program product of claim 13, wherein generating the 3D facial model includes generating one or more mesh files that define a representation of the 3D facial model across the multiple frames of the electronic video file.

15. The computer program product of claim 14, wherein the 3D facial model captured in the one or more mesh files mimics a facial shape, facial expression, appearance, and pose of the facial object in a 3D environment.

16. The computer program product of claim 13, wherein deriving the camera parameters further comprises deriving a focal length of the camera, and utilizing the focal length to derive the camera pose.

17. The computer program product of claim 13, wherein extracting the facial object data by the extraction layer of the computer vision system includes:
executing a landmark detection model to extract the facial landmark data corresponding to the facial object across the multiple frames of the electronic video file;
executing an edge detection model to extract the edge data corresponding to the facial object across the multiple frames of the electronic video file; and
executing a facial segmentation model to extract the facial segmentation data corresponding to the facial object across the multiple frames of the electronic video file.

18. The computer program product of claim 13, wherein generating the 3D facial model includes executing a post-processing operations that utilizes a contour fitting function configured to enhance facial contours of the 3D facial model.
